(19) United States
(12) Patent Application Publication
(10) Pub. No.: US 2011/0189347 A1
(43) Pub. Date: Aug. 4, 2011

(54) USE OF SUCCINIC ACID

(76) Inventors: Jiri Broz, Rheinfelden (CH); Aurelia Seon, Mulhouse (FR); Carlos Simoes-Nunes, Village-Neuf (FR)

(21) Appl. No.: 12/995,433

(22) PCT Filed: Jun. 2, 2009
(86) PCT No.: PCT/EP2009/055901

§ 371 Date: Mar. 3, 2011

(30) Foreign Application Priority Data
May 30, 2008 (EP) 08009909.6

(51) Int. Cl. A23L 1/30; A23L 1/00; A23J 1/00

(52) U.S. Cl. 426/72; 426/531; 426/656

(57) ABSTRACT

This invention relates to a composition comprising Succinic Acid or a derivative thereof. It has been surprisingly found that Succinic Acid and derivatives thereof have a great potential for use in animal feed, e.g. for improving the feed conversion ratio (FCR) and/or for modulation of the gut flora. It is therefore the main object of the present invention to provide compositions and methods for the use of Succinic Acid in animal feed.

The present invention relates to a novel use of a nutraceutical composition for animals, especially pigs, comprising as active ingredient succinic acid, derivatives or metabolites thereof.

Specific examples of derivatives of succinic acid include salts of succinic acid such as the alkali metal-alkaline earth metal- and ammonium succinates.

The term “nutraceutical” as used herein denotes a usefulness in both the nutritional and pharmaceutical field of application. Thus, the nutraceutical compositions can find use as a complete animal feed (diet), as supplement to animal feed, and as pharmaceutical formulations for enteral or parenteral application which may be solid formulations, or liquid formulations.

The term animal includes all animals including human. Examples of animals are non-ruminants, and ruminants. Ruminant animals include, for example, animals such as sheep, goat, and cattle, e.g. cow such as beef cattle and dairy cows. In a particular embodiment, the animal is a non-ruminant animal. Non-ruminant animals include mono-gastric animals, e.g. pig or swine (including, but not limited to, piglets, growing pigs, and sows); poultry such as turkeys, ducks and chickens (including but not limited to broiler chicks, layers); fish (including but not limited to salmon, trout, tilapia, catfish and carp); and crustaceans (including but not limited to shrimp and prawn).

The term feed or feed composition means any compound, preparation, mixture, or composition suitable for, or intended for intake by an animal.

The use of organic acids in animal feeding is known. For example, EP-A-0 683 985 discloses a feed compositions comprising benzoic acid or salts thereof, which can be used to minimize the emission of odoriferous ammonia from organic wastes in pig farms, especially animal excrements and manure. It is further known that addition of benzoic acid to the diet of weaner piglets improves the zootechnical performance of the animals.

It is also known that other organic acids, as for example citric- or butyric acid, may be used in animal nutrition as potential alternatives to antibiotic growth promoters, especially for pigs. Up to now, the use of succinic acid in animal nutrition has not been described.

The present inventors surprisingly found that succinic acid and derivatives thereof have a great potential for use in animal feed, e.g. for improving daily weight/mean gain of the animal and/or for improving the feed conversion ratio (FCR).

The present inventors surprisingly found that succinic acid has also antimicrobial activity and furthermore the potential to modulate the gut flora of the animal.

Antimicrobial activity may, e.g., be bactericidal, bacteriostatic, fungicidal, fungistatic, and/or virucidal. The term “bactericidal” is to be understood as capable of killing bacterial cells; the term “bacteriostatic” as capable of inhibiting bacterial growth, i.e. inhibiting growing bacterial cells; the term “fungicidal” as capable of killing fungal cells; the term “fungistatic” as capable of inhibiting fungal growth, i.e. inhibiting growing fungal cells; and the term “virucidal” is to be understood as capable of inactivating virus.

It is the main object of the present invention to provide compositions and methods for the use of succinic acid in animal feed.

Succinic acid is either commercially available or can easily be prepared by a skilled person using processes and methods well-known in the prior art.

For the use in animal feed, however, succinic acid need not be that pure; it may include other alkyl derivatives and/or it may be extracted and purified from biomass if it is produced by a microorganism, for example by a recombinant or non-recombinant eukaryotic cell as yeast.

It is a second aspect of the invention to use succinic acid in animal feeding for improving daily weight/mean gain and/or feed conversion ratio (FCR) and/or for modulation of the gut flora of the animal.

In the present context, the term Feed Conversion Ratio, or FCR, is used synonymously with the term feed conversion. The FCR is calculated as the feed intake in g/animal relative to the weight gain in g/animal.

A third aspect of the invention relates to a premix or additive composition and to an animal feed containing a composition comprising succinic acid.

Succinic acid or a derivative thereof may be administrated to the animals as a component of a nutraceutical composition which is conventionally fed to animals. Thus, succinic acid and derivatives thereof may be suitably administered to the animals as a component of the animal feed or in their drinking water.

The amount of succinic acid or a derivative thereof administered to the animal is in the range from 0.1-5% based on the total weight of each feed fed to the animal. In a preferred embodiment of the invention succinic acid or a derivative of succinic acid being used in an amount sufficient to provide a daily dosage of 300 mg per kg body weight to about 15000 mg per kg body weight of the animal to which it is to be administered.

In a first particular embodiment, the invention relates to methods for using succinic acid in animal feed, e.g. for improving the Feed Conversion Ratio (FCR) and/or for modulation of the gut microflora. In alternative embodiments, succinic acid improves animal feed digestibility, and/or maintains animal health by aiding in proper digestion and/or supporting immune system function.

The FCR may be determined on the basis of a piglet growth trial comprising a first treatment in which succinic acid is added to the animal feed in a suitable concentration per kg feed, and a second treatment (control) with no addition of succinic acid to the animal feed.

As it is generally known, an improved FCR is lower than the control FCR. In particular embodiments, the FCR is improved (i.e., reduced) as compared to the control by at least 1.0%, preferably at least 1.5%, 1.6%, 1.7%, 1.8%, 1.9%, 2.0%, 2.1%, 2.2%, 2.3%, 2.4%, or at least 2.5%.

The term “gut” as used herein designates the gastrointestinal or digestive tract (also referred to as the alimentary canal) and it refers to the system of organs within multicellular animals which takes in food, digests it to extract energy and nutrients, and expels the remaining waste.

The term gut “microflora” as used herein refers to the natural microbial cultures residing in the gut and maintaining health by aiding in proper digestion and/or supporting immune system function.

The term “modulate” as used herein in connection with the gut microflora generally means to change, manipulate, alter, or adjust the function or status thereof in a healthy and normally functioning animal, i.e. a non-therapeutic use. The modulation is in response to succinic acids and/or the microorganism strains of the invention.

The following are non-limiting particular examples of the gut microflora modulation effect obtained by succinic acid of the invention (changes as compared to a control without succinic acid of the invention):

(i) a decrease in the frequency with which Salmonella spp and/or Clostridium perfringens occurs in vivo, for example in piglets or in broilers;
(ii) a decrease in the number of Escherichia coli and/or Enterococcus faecalis in vivo, for example in piglets and/or broilers,

Still further, also in relation to the gut microflora modulating effect, and with reference to a control without succinic acid of the invention, succinic acid of the invention preferably:

(iii) does substantially influence, e.g. reduce, the growth in vitro of harmful microorganisms, such as bacteria, for example as isolated from piglet and/or broiler intestinal contents.

In a second particular embodiment, the invention relates to a premix or additive composition and to an animal feed containing a composition comprising succinic acid.

In a preferred embodiment of a feed for piglets, succinic acid or a derivative of succinic acids being used in an amount sufficient to provide a daily dosage of 300 mg per kg body weight to about 15000 mg per kg body weight, of the subject to which it is to be administered. The amount of succinic acid or of a derivative thereof in a final pig feed is in the range from 1 to 50 g/kg feed, preferably in the range of 10 to 20 and in a final poultry feed is in the range from 1 to 40 g/kg feed, preferably in the range of 2 to 10.

Particular examples of compositions of the invention are the following:
An animal feed additive comprising (a) succinic acid, (b) at least one fat-soluble vitamin, (c) at least one water-soluble vitamin, (d) at least one trace mineral, and/or (e) at least one macro mineral;
An animal feed composition comprising (a) succinic acid and a crude protein content of 50 to 800 g/kg feed.
An animal feed composition having a crude protein content of 50 to 800 g/kg and comprising a strain of microorganism as defined above.

The so-called premixes are examples of animal feed additives of the invention. A premix designates a preferably uniform mixture of one or more micro-ingredients with diluent and/or carrier. Premixes are used to facilitate uniform dispersion of micro-ingredients in a larger mix.

Further, optional, feed-additive ingredients are coloring agents, e.g. carotenoids such as beta-carotene, astaxanthin, and lutein; aroma compounds; stabilisers; antimicrobial peptides; polyunsaturated fatty acids; reactive oxygen generating species; and/or at least one enzyme selected from amongst phytase (EC 3.1.3.8 or 3.1.3.26); xylanase (EC 3.2.1.8); galactanase (EC 3.2.1.89); alpha-galactosidase (EC 3.2.1.22); protease (EC 3.4.), phospholipase A1 (EC 3.1.1.32); phospholipase A2 (EC 3.1.1.4); lysophospholipase (EC 3.1.1.5); phospholipase C (EC 3.1.4.3); phospholipase D (EC 3.1.4.4); amylase such as, for example, alpha-amylase (EC 3.2.1.1); and/or beta-glucanase (EC 3.2.1.4 or EC 3.2.1.6).

Examples of polyunsaturated fatty acids are C18, C20 and C22 polyunsaturated fatty acids, such as arachidonic acid, docosohexaenoic acid, eicosapentaenoic acid and gamma-linoleic acid.

Examples of reactive oxygen generating species are chemicals such as perborate, persulphate, or percarbonate; and enzymes such as an oxidase, an oxygenase or a syntethase.

Usually fat- and water-soluble vitamins, as well as trace minerals form part of a so-called premix intended for addition to the feed, whereas macro minerals are usually separately added to the feed. Either of these composition types, when enriched with succinic acid, is an animal feed additive of the invention.

The following are non-exclusive lists of examples of these components:

Examples of fat-soluble vitamins are vitamin A, vitamin D3, vitamin E, and vitamin K, e.g. vitamin K3.
Examples of water-soluble vitamins are vitamin B12, biotin and choline, vitamin B1, vitamin B2, vitamin B6, niacin, folic acid and panthothenate, e.g. Ca-D-panthothenate.
Examples of trace minerals are manganese, zinc, iron, copper, iodine, selenium, and cobalt.

Examples of macro minerals are calcium, phosphorus and sodium.

The nutritional requirements of these components (exemplified with poultry and piglets/pigs) are listed in Table A of WO 01/58275. Nutritional requirement means that these components should be provided in the diet in the concentrations indicated.

In the alternative, the animal feed additive of the invention comprises at least one of the individual components specified in Table A of WO 01/58275. At least one means either of, one or more of, one, or two, or three, or four and so forth up to all thirteen, or up to all fifteen individual components. More specifically, this at least one individual component is included in the additive of the invention in such an amount as to provide an in-feed-concentration within the range indicated in column four, or column five, or column six of Table A.

Animal feed compositions or diets have a relatively high content of protein. Poultry and pig diets can be characterized as indicated in Table B of WO 01/58275, columns 2-3. Fish diets can be characterized as indicated in column 4 of this Table B. Furthermore such fish diets usually have a crude fat content of 200-310 g/kg.

WO 01/58275 corresponds to U.S. Ser. No. 09/779,334 which is hereby incorporated by reference.

An animal feed composition according to the invention has a crude protein content of 50-800 g/kg, and furthermore comprises succinic acid as described and/or claimed herein.

Furthermore, or in the alternative (to the crude protein content indicated above), the animal feed composition of the invention has a content of metabolisable energy of 10-30 MJ/kg; and/or a content of calcium of 0.1-200 g/kg; and/or a content of available phosphorus of 0.1-200 g/kg; and/or a content of methionine of 0.1-100 g/kg; and/or a content of methionine plus cysteine of 0.1-150 g/kg; and/or a content of lysine of 0.5-50 g/kg.

In particular embodiments, the content of metabolisable energy, crude protein, calcium, phosphorus, methionine, methionine plus cysteine, and/or lysine is within any one of ranges 2, 3, 4 or 5 in Table B of WO 01/58275 (R. 2-5).

Crude protein is calculated as nitrogen (N) multiplied by a factor 6.25, i.e. Crude protein (g/kg)=N (g/kg)×6.25. The nitrogen content is determined by the Kjeldahl method (A.O.A.C., 1984, Official Methods of Analysis 14th ed., Association of Official Analytical Chemists, Washington D.C.).

Metabolisable energy can be calculated on the basis of the NRC publication Nutrient requirements in swine, ninth revised edition 1988, subcommittee on swine nutrition, committee on animal nutrition, board of agriculture, national research council. National Academy Press, Washington, D.C., pp. 2-6, and the European Table of Energy Values for Poultry Feed-stuffs, Spelderholt centre for poultry research and extension, 7361 DA Beekbergen, The Netherlands. Grafisch bedrijf Ponsen & looijen by, Wageningen. ISBN 90-71463-12-5.

The dietary content of calcium, available phosphorus and amino acids in complete animal diets is calculated on the basis of feed tables such as Veevoedertabel 1997, gegevens over chemische samenstelling, verteerbaarheid en voederwaarde van voedermiddelen, Central Veevoederbureau, Runderweg 6, 8219 pk Lelystad. ISBN 90-72839-13-7.

In a particular embodiment, the animal feed composition of the invention contains at least one vegetable protein or protein source. It may also contain animal protein, such as Meat and Bone Meal, and/or Fish Meal, typically in an amount of 0-25%. The term vegetable proteins as used herein refers to any compound, composition, preparation or mixture that includes at least one protein derived from or originating from a vegetable, including modified proteins and protein-derivatives. In particular embodiments, the protein content of the vegetable proteins is at least 10, 20, 30, 40, 50, or 60% (w/w).

Vegetable proteins may be derived from vegetable protein sources, such as legumes and cereals, for example materials from plants of the families Fabaceae (Leguminosae), Cruciferaceae, Chenopodiaceae, and Poaceae, such as soy bean meal, lupin meal and rapeseed meal.

In a particular embodiment, the vegetable protein source is material from one or more plants of the family Fabaceae, e.g. soybean, lupine, pea, or bean.

In another particular embodiment, the vegetable protein source is material from one or more plants of the family Chenopodiaceae, e.g. beet, sugar beet, spinach or quinoa.

Other examples of vegetable protein sources are rapeseed, sunflower seed, cotton seed, and cabbage.

Other examples of vegetable protein sources are cereals such as barley, wheat, rye, oat, maize (corn), rice, triticale, and sorghum.

In still further particular embodiments, the animal feed composition of the invention contains 0-80% maize; and/or 0-80% sorghum; and/or 0-70% wheat; and/or 0-70% Barley; and/or 0-30% oats; and/or 0-30% rye; and/or 0-40% soybean meal; and/or 0-25% fish meal; and/or 0-25% meat and bone meal; and/or 0-20% whey.

Animal diets can e.g. be manufactured as mash feed (non pelleted) or pelleted feed. Typically, the milled feed-stuffs are mixed and sufficient amounts of essential vitamins and minerals are added according to the specifications for the species in question. Succinic acid and/or the derivative thereof can be added as solid or liquid formulations.

The following examples further illustrate the invention, but they should not be construed as limiting the invention.

### EXAMPLE 1

### Animal Feed Additive

An animal feed additive is prepared by adding 100 g of succinic acid to the following premix (per kilo of premix):

| | | |
|---|---|---|
| 1100000 | IE | Vitamin A |
| 300000 | IE | Vitamin D3 |
| 4000 | IE | Vitamin E |
| 250 | mg | Vitamin B1 |
| 800 | mg | Vitamin B2 |
| 1200 | mg | Ca-D-Panthothenate |
| 500 | mg | Vitamin B6 |
| 2.5 | mg | Vitamin B12 |
| 5000 | mg | Niacin |
| 10000 | mg | Vitamin C |
| 300 | mg | Vitamin K3 |
| 15 | mg | Biotin |
| 150 | mg | Folic acid |
| 50004 | mg | Cholin chloride |
| 6000 | mg | Fe |
| 3000 | mg | Cu |
| 5400 | mg | Zn |
| 8000 | mg | Mn |
| 124 | mg | I |
| 60 | mg | Co |
| 29.7 | mg | Se |
| 9000 | mg | Lasalocid Sodium (Avatec) |

| | |
|---|---|
| 17.3% | Ca |
| 0.8% | Mg |
| 11.7% | Na |

### EXAMPLE 2

### Animal Feed

A broiler grower diet having the following composition (%, w/w) is prepared by mixing the ingredients. Wheat, rye and SBM 48 are available from Moulin Moderne Hirsinque, Hirsingue, France. After mixing, the feed is pelleted at a desired temperature, e.g. about 70° C. (3×25 mm).

| | |
|---|---|
| Wheat | 46.00 |
| Rye | 15.00 |
| Soy Bean Meal (SBM 48) | 30.73 |
| Soybean oil | 4.90 |
| DL-Methionine | 0.04 |
| DCP (Di-Calcium Phosphate) | 1.65 |
| Limestone | 0.43 |
| Salt | 0.15 |
| TiO2 | 0.10 |
| Animal feed additive (above) | 1.00 |

The resulting animal feed comprises 1 g succinic acid per kg (1000 ppm).

Additional animal feed and feed additive compositions can be prepared in a similar manner.

### EXAMPLE 3

### Evaluation of the Effects of Succinic Acid on Gut Microflora In Vitro

The comparative antimicrobial activity of succinic acid (118.1 g/mol) and citric acid (210.14 g/mol) on microorganisms isolated from the piglet gastrointestinal microflora were evaluated in vitro. Their identities were confirmed by microscopic examination after Gram staining and biochemical tests using the appropriate API system (BioMerieux, Marcy l'Etoile, France).

The effects of succinic and citric acid on the bacterial growth of these bacteria were determined by micro titre broth dilution method measuring absorbance at 595 nm. All the in vitro assays were performed in sterilized 96-well plates (Falcon 353072 microtiter plates, Becton Dickinson Labware, Meylan, France) in a final volume of 200 microlitre as follows: 100 microlitre of suspension containing approximately 105 CFU/ml of the pure bacteria in the appropriate broth were added to 100 microlitre of broth containing succinic or citric acid in serial 2-fold dilutions or to 100 microlitre of broth as control. Inhibition of growth was determined by measuring absorbance at 595 nm with a Multiskan Ascent (ThermoLabsystems, Helsinki, Finland) after the appropriate time of incubation at the appropriate temperature for the optimal growth of the pure bacteria.

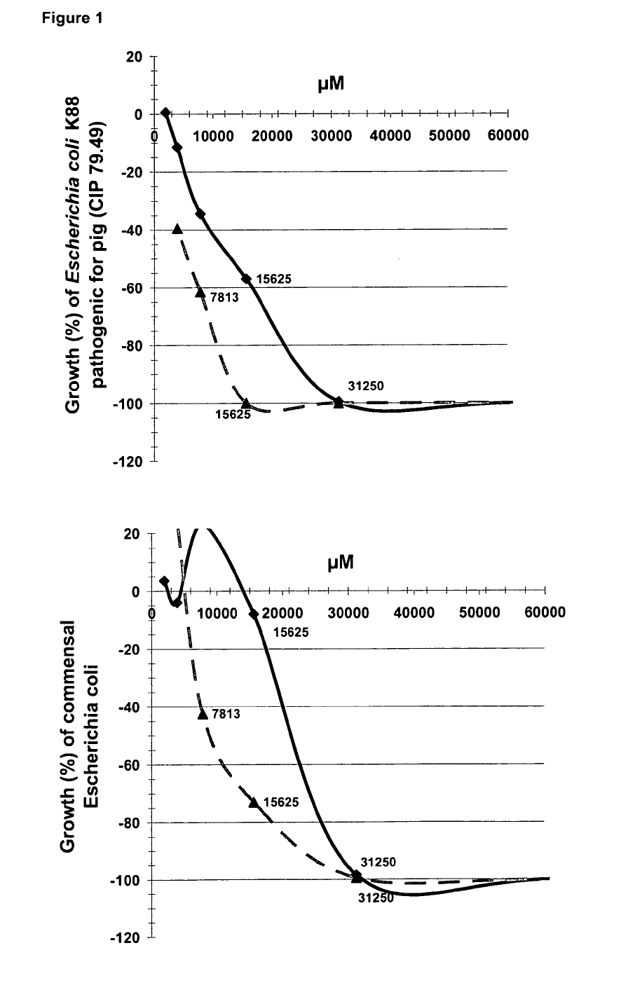

The reduction in culture density was determined by subtracting the OD595 of the test culture after 24 or 48 hours from the OD595 of the control culture. Reduction in culture density was normalized by expressing it as a percentage of the OD595 of the control culture. MIC90 corresponded to the concentration of acid required to reduce culture density by 90%, meaning to inhibit the growth of 90% of the organisms tested (MIC90 being defined as the Minimum Inhibitory Concentration required to inhibit the growth of 90% of organisms). The results of these evaluations are shown in FIGS. 1 to 4.

The potentially harmful microorganisms preferably selected were a commensal Escherichia coli, a pathogenic Escherichia coli K88, Salmonella enterica subsp enterica serovar Enteritidis and Typhimurium, Enterococcus faecalis and Clostridium perfringens for which the MIC90 of succinic acid and citric acid are comparable and preferably below 31250 μM (3.69 g/l) which are at least 50% smaller than a MIC90 for a beneficial Gram positive bacillus such as a strain of Lactobacillus acidophilus. For another beneficial Gram positive bacillus such as a strain of Lactobacillus fermentum, MIC90 of succinic acid and citric acid were below 125000 μM. Succinic and citric acids are more active against the tested harmful bacteria isolated from piglet content than for beneficial ones.

The results are further illustrated in FIGS. 1 to 4.

FIG. 1: In vitro antimicrobial activity of succinic acid (black curve) and citric acid (gray curve) against Escherichia coli

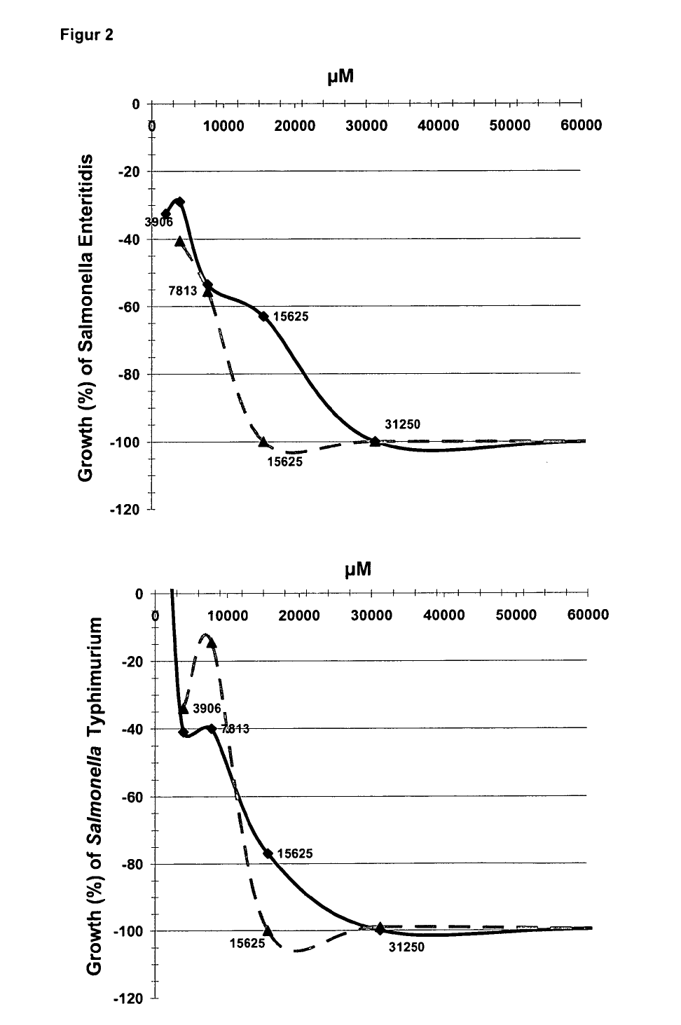

FIG. 2: In vitro antimicrobial activity of succinic acid (black curve) and citric acid (gray curve) against Salmonella enterica subsp enterica serovar Enteritidis and Typhimurium

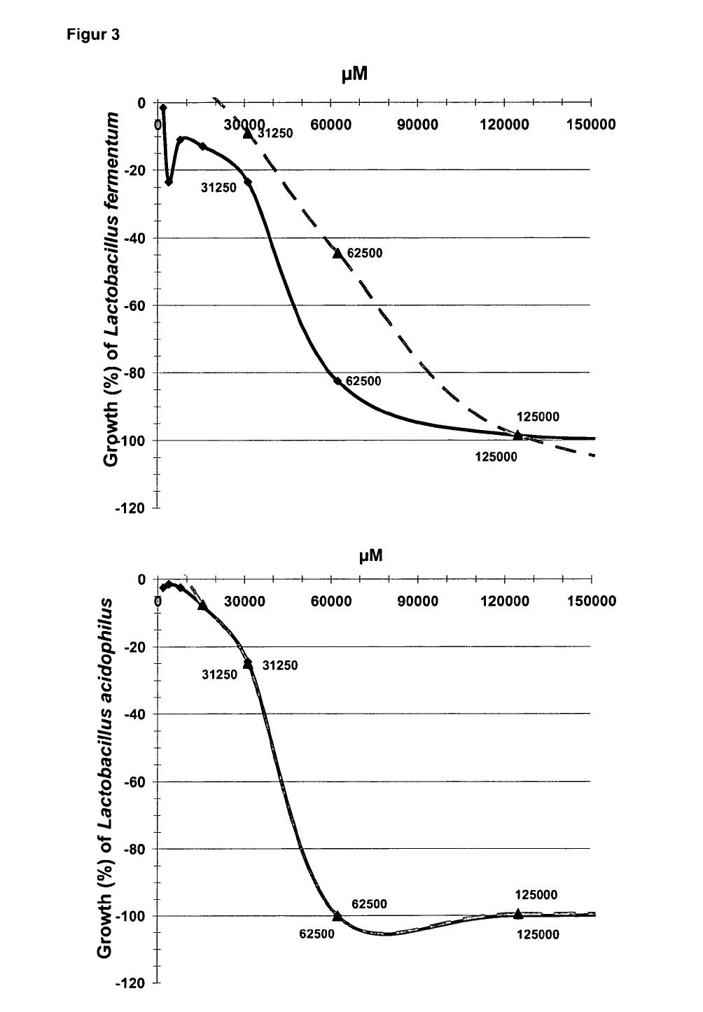

FIG. 3: In vitro antimicrobial activity of succinic acid (black curve) and citric acid (gray curve) against Lactobacillus fermentum and Lactobacillus acidophilus

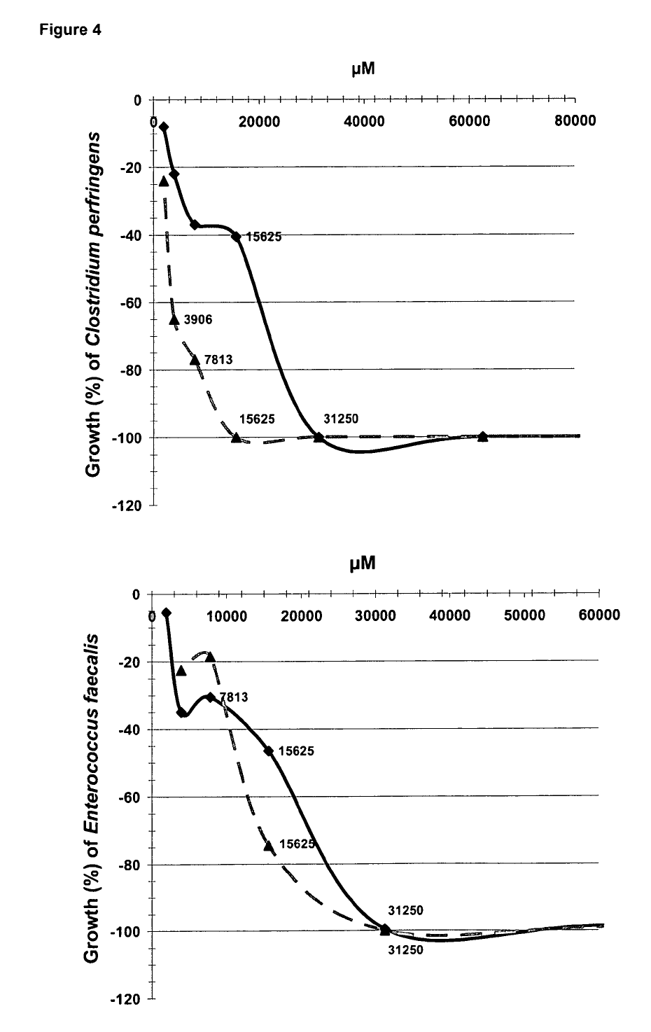

FIG. 4: In vitro antimicrobial activity of succinic acid (black curve) and citric acid (gray curve) against Clostridium perfringens and Enterococcus faecalis

### EXAMPLE 4

### Evaluation of the Effect of succinic acid in weaned piglets diets 72 early weaner piglets were used. The animals were divided into 18 pens (4 animals per pen) The animals were fed the basal diet (group T1) or the diet with addition of 1% of succinic acid proived by DSM Fine Chemicals Linz, Austria (group T2).

Each dietary treatment was assigned to 9 replicate groups (36 piglets/treatment) as follows:
Diet and feeding: Standard starter diet based on maize, barley, dried whey and soybean meal as the main feed ingredients (18.7% CP, 14.2 MJ ME/kg), fed ad libitum in pelleted form. Test product: Succinic acid provided by DSM Fine Chemicals, Linz, Austria.
Dietary treatments:
   T-1) Negative control (basal diet)
   T-2) succinic acid at 1.0%.
Experimental parameters: Live weight gain (days 0, 14, 24 and 36), daily weight gain (days 0-14, 14-24, 24-36 and overall), feed intake (per period & overall), feed/gain ratio (per period & overall), mortality.

These results are summarised in the following tables 1 and 2.

TABLE 1

Treatment

| | |
|---|---|
| T-1 | T-2 |

Compound

| Dietary inclusion (%) | Neg. Control 0 | Succinic acid 1.0 |
|---|---|---|
| Live weight of piglets (kg) | | |
| Initial, day 0 | 8.39 | 8.51 |
| Day 14 | 12.10 | 12.01 |
| Day 24 | 16.80 | 16.90 |
| Final, day 36 | 24.59 | 24.32 |
| Daily weight gain (g) | | |
| Day 0-14 | 265 | 250 |
| Day 14-24 | 469 | 489 |
| Day 24-36 | 649 | 618 |
| Overall, day 0-36 | 450 | 439 |
| Index (%) | 100.0 | 97.6 |

TABLE 2

Treatment

| | |
|---|---|
| T-1 | T-2 |

Compound

| Dietary inclusion (%) | Neg. Control 0 | Succinic acid 1.0 |
|---|---|---|
| Daily feed intake (g)) | | |
| Day 0-14 | 493 | 368 |
| Day 14-24 | 660 | 649 |
| Day 24-36 | 894 | 869 |
| Overall, day 0-36 | 673 | 613 |
| Feed conversion | | |
| (feed/gain ratio) | | |
| Day 0-14 | 1.86 | 1.48 |
| Day 14-24 | 1.43 | 1.33 |
| Day 24-36 | 1.38 | 1.41 |
| Overall, day 0-36 | 1.50 | 1.40 |
| Index (%) | 100.0 | 93.3 |

The results clearly show that dietary addition of succinic acid at the dietary level of 1.0% caused certain numerical reduction of feed intake, in particular during the first trial period (day 0-14, −25.4%), which resulted in a remarkable improvement of feed conversion.

### EXAMPLE 5

### Evaluation of the Effects of Dietary Supplementation with Succinic Acid on the Zootechnical Performance of the Weaner Piglet

Forty-eight 28-day old Large-White×Landrace weaner piglets having an initial body weight of 8.1±0.88 kg were used. The animals were allocated into two equal groups (A and B) and housed in cages in sub-groups of 7 (2 sub-groups for each group) and 5 animals (2 sub-groups for each group) in an environmentally controlled room. Each cage had a plastic-coated welded wire floor and was equipped with 2 water nipples and 2 stainless-steel feeders. Room temperature was initially 27° C. and was lowered weekly by about 2° C. until 21-22° C. Environment humidity percentage throughout the experiment was 50%.

The animals were fed for 29 days either the basal diet (group A) or the diet A with addition of succinic acid (DSM Fine Chemicals) at the level of 0.5% (group B). The basal diet A was formulated to meet the animals' requirements. The composition of the basal diet is presented in the table 3.

Performance was evaluated for the 29 days of the trial duration. The health status has been controlled daily.

The results are summarized in tables 4 and 5.

The group ingesting the diet with the succinic acid had numerically higher DWG (+5%) than that observed for the control group. The feed intake was numerically increased by the dietary supplementation.

The present experiment confirmed that succinic acid included in the piglet diet at level of 0.5% improved the daily mean gain of the weaner piglet.

TABLE 3
Composition and characteristics (%) of the experimental diets

| | | |
|---|---|---|
| Ingredients (%) | A | B |

| | |
|---|---|
| Soya bean meal | 7.5 |
| Wheat | 18.8 |
| Barley | 29 |
| Potato concentrate | 8 |
| Maize | 10 |
| Oat meal | 10 |
| Beet pulp | 5.4 |
| Beet sugar | 3.5 |
| Soy oil | 2.7 |
| Wheat starch | 1.6 |
| Minerals, synthetic amino acids, trace | 3.5 |
| elements and vitamins premix(1) | |

| | | |
|---|---|---|
| Succinic acid (%) | 0 | 0.5 |

(1)mixture without organic acids

TABLE 4
Effects of succinic acid on the piglet performance.

| | |
|---|---|
| A (n = 24) | B (n = 24) |

Daily weight gain (g)

| | |
|---|---|
| 217 ± 56 | 227 ± 66 |
| (100) | (105) |

Weight gain (kg)

| | |
|---|---|
| 6.28 ± 1.63 | 6.57 ± 1.91 |
| (100) | (105) |

TABLE 5
Effects of succinic acid on the piglet performance.

| | |
|---|---|
| A (n = 4) | B ( n = 4) |

Feed intake (g/day)

| | |
|---|---|
| 401 ± 45 | 416 ± 37 |
| (100) | (104) |

### EXAMPLE 6

### Evaluation of the Effects of Succinic Acid at Different Dosages on the Growth Performance of Broiler Chickens Over Five Weeks

The objective of the present trial (Trial A) was to evaluate the effects of sucinic acid on the growth performance of broiler chickens in a floor pen trial over five weeks. Succinic acid was supplemented at four different dose levels.

Day-old male and female broiler chickens were divided by weight into groups of 20 birds. Each group was placed in one floor pen littered with wood shavings and allocated to one of the different treatments. Each treatment was replicated with 4 groups per sex.

Birds had ad libitum access to feed and tap water. Groups were weighed on days 1, 22 and 36. The feed consumption for the intermediate periods was determined and body weight gain and feed conversion ratio (FCR) were calculated.

Chickens received diets based on soybean meal, and wheat as main ingredients (Table 6). Apart from the control treatment that was without product supplementation, the other treatments contained the antibiotic Avilamycin (Maxus 200) included at 10 mg per kg feed as a positive control and succinic acid (lot 57501 (Sigma product)) included at 2.5 g, 5.0 g, 7.5 g and 10.0 g per kg feed.

The target quantities of succinic acid were added on top to the feed, mixed with appropriate amounts of maize starch as a carrier:

Starter diet: control=0 mg of succinic acid+3000 mg of maize starch per kg feed, for the following treatment, the maize starch was replaced by succinic acid: 750 mg of succinic acid+2250 mg of maize starch per kg feed, 1500 mg of succinic acid+1500 mg of maize starch per kg feed, 2250 mg of succinic acid+750 mg of maize starch per kg feed, 3000 mg of succinic acid+0 mg of maize starch per kg feed
Grower diet: control=0 mg of succinic acid+5000 mg of maize starch per kg feed, for the following treatment, the maize starch was replaced by succinic acid: 1250 mg of succinic acid+3750 mg of maize starch per kg feed, 2500 mg of succinic acid+2500 mg of maize starch per kg feed, 3750 mg of succinic acid+1250 mg of maize starch per kg feed, 5000 mg of succinic acid+0 mg of maize starch per kg feed

Feed samples were collected to determine the concentration of succinic acid (Table 7).

For the statistical evaluation of the data, a one-factorial analysis of variance for each diet (factor: treatment) was carried out. Where significant treatment effects (p<0.05) were indicated, the differences among treatment means were subsequently analyzed with the Newman-Keuls test.

In Table 8 the results of the growth performance are listed for the starter period (day 1-22), for the grower period (day 22-36) and for the whole experimental period from day 1 to day 36. There were no significant interactions between treatment and sex, so that the pooled results of both sexes are presented.

In the starter period, the weight gain was significantly improved by the supplementation of succinic acid compared to the control treatment. An improvement in a range of 3.9% to 10.5% was obtained with the different inclusions levels of succinic acid. The supplementation of 5 g succinic acid per kg feed resulted in weight gain comparable to the supplementation with the antibiotic growth promoter Avilamycin per kg feed. The feed conversion ratio (FCR) was significantly improved by the inclusion of succinic acid at 2.5 g, 7.5 g and 10 g per kg feed compared to the control treatment respectively by 5.7%, 5.2% and 4.6%.

Over the whole period from day 1 to day 36, the weight gain was numerically improved by succinic acid supplementation. An numerical improvement by 3.6% and 4.5% respectively was noted for the supplementation with 2.5 g and 7.5 g succinic acid per kg feed compared to the control.

In conclusion, the organic acid seemed to be effective in improving the growth performance of broiler chickens. Most beneficial effects were found during starter period.

TABLE 6
Composition of the basal diet

| | Starter | Grower |
|---|---|---|
| Ingredients (%) | | |
| Wheat | 37.3 | 40.9 |
| mAize | 20.0 | 20.0 |
| Soybean meal (50% CP) | 35.1 | 31.9 |
| Soybean oil | 3.60 | 3.80 |
| DL-Methionine | 0.15 | 0.05 |
| DCP | 1.95 | 1.55 |
| CaCO3 | 0.65 | 0.53 |
| NaCl | 0.20 | 0.15 |
| Premix1 | 1.00 | 1.00 |
| Avatec | 0.06 | 0.06 |
| Titane dioxyde | — | 0.10 |
| Calculated content: | | |
| Crude protein (g/kg) | 222 | 210 |
| MEN(MJ/kg)2 | 12.5 | 12.7 |
| Lysine (%) | 1.2 | 1.1 |
| Methionine + Cystine (%) | 0.9 | 0.7 |

1including vitamins and trace minerals
2Calculated with EC-equation

TABLE 7
Analysed product activity in samples of the experimental diets

| | | | | Succinic acid content | |
|---|---|---|---|---|---|
| | | | | (g/kg feed) | |
| Treatment | Product | Dose | | Starter | Grower |
| A | Control | — | | 0 | 0 |
| B | Avilamycin | 10 | mg/kg | 0 | 0 |
| C | Succinic acid | 2.5 | g/kg | 2.48 | 2.54 |
| D | Succinic acid | 5.0 | g/kg | 4.97 | 5.09 |
| E | Succinic acid | 7.5 | g/kg | 7.5 | 9.60 |
| F | Succinic acid | 10.0 | g/kg | 9.85 | 10.13 |

TABLE 8
Performance of both sexes (Day 1 to day 36) mean ± stdev

| Product | | | Succinic acid | | | |
|---|---|---|---|---|---|---|
| Treatment | Control A | Avilamycin B | C | D | E | F |
| Dose (mg/kg) | — | 10 mg/kg | 2.5 g/kg | 5 g/kg | 7.5 g/kg | 10 g/kg |
| Number of pen × | 8 × 20 | 8 × 20 | 8 × 20 | 8 × 20 | 8 × 20 | 8 × 20 |
| birds | | | | | | |
| Day 1-22 | | | | | | |
| Weight gain (g) | 954^{C} | 992^{BC} | 1046^{A} | 991^{BC} | 1054^{A} | 1036^{AB} |
| | ±34 | ±48 | ±49 | ±46 | ±67 | ±55 |
| | 100 | 104.1 | 109.7 | 103.9 | 110.5 | 108.6 |
| Feed intake (g) | 1381^{A} | 1450^{A} | 1427^{A} | 1446^{A} | 1445^{A} | 1430^{A} |
| | ±57 | ±100 | ±44 | ±63 | ±73 | ±72 |
| | 100 | 105 | 103.4 | 104.8 | 104.6 | 103.6 |
| Feed conversion | 1.448^{A} | 1.462^{A} | 1.365^{B} | 1.461^{A} | 1.372^{B} | 1.381^{B} |
| (g feed/g gain) | ±0.044 | ±0.102 | ±0.032 | ±0.052 | ±0.052 | ±0.051 |
| | 100 | 101.0 | 94.3 | 100.9 | 94.8 | 95.4 |
| Day 22-36 | | | | | | |
| Weight gain (g) | 1348^{A} | 1366^{A} | 1337^{A} | 1320^{A} | 1350^{A} | 1311^{A} |
| | ±92 | ±110 | ±50 | ±119 | ±131 | ±124 |
| | 100 | 101.4 | 99.2 | 98.0 | 100.2 | 97.3 |
| Feed intake (g) | 2354^{A} | 2412^{A} | 2392^{A} | 2347^{A} | 2431^{A} | 2442^{A} |
| | ±111 | ±123 | ±66 | ±84 | ±146 | ±150 |
| | 100 | 102.5 | 101.6 | 99.7 | 103.3 | 103.8 |
| Feed conversion | 1.750^{A} | 1.769^{A} | 1.790^{A} | 1.786^{A} | 1.806^{A} | 1.870^{A} |
| (g feed/g gain) | ±0.085 | ±0.072 | ±0.033 | ±0.130 | ±0.069 | ±0.114 |
| | 100 | 101.1 | 102.3 | 102.1 | 103.2 | 106.9 |
| Day 1-36 | | | | | | |
| Weight gain (g) | 2301^{A} | 2359^{A} | 2383^{A} | 2311^{A} | 2404^{A} | 2347^{A} |
| | ±105 | ±130 | ±93 | ±100 | ±183 | ±167 |
| | 100 | 102.5 | 103.6 | 100.4 | 104.5 | 102.0 |
| Feed intake (g) | 3734^{A} | 3860^{A} | 3817^{A} | 3793^{A} | 3870^{A} | 3868^{A} |
| | ±159 | ±175 | ±99 | ±139 | ±211 | ±208 |
| | 100 | 94.3 | 102.2 | 101.6 | 103.7 | 103.6 |
| Feed conversion | 1.623^{A} | 1.638^{A} | 1.602^{A} | 1.642^{A} | 1.612^{A} | 1.651^{A} |
| (g feed/g gain) | ±0.032 | ±0.040 | ±0.027 | ±0.053 | ±0.042 | ±0.068 |
| | 100 | 100.9 | 98.7 | 101.2 | 99.4 | 101.7 |

### EXAMPLE 7

### Evaluation of the Effects of Dietary Supplementation with Succinic Acid in Combination with Dihydroeugenol on the Zootechnical Performance of the Weaner Piglet

One hundred and twenty 28-day old Large-White×Landrace weaner piglets having an initial body weight of 8±0.84 kg were used. The animals were allocated into five equal groups (A, B, C, D and E) and housed in cages in sub-groups of 7 (2 sub-groups for each group) and 5 animals (2 sub-groups for each group) in an environmentally controlled room. Each cage had a plastic-coated welded wire floor and was equipped with 2 water nipples and 2 stainless-steel feeders. Room temperature was initially 27° C. and was lowered weekly by about 2° C. until 21-22° C. Environment humidity percentage throughout the experiment was 50%.

The animals were fed for 32 days either the basal diet (group A) or the diet A with addition of 0.5% succinic acid (batch SYGB106) and 200 ppm of dihydroeugenol (batch 07339TT) (group B), the diet A with addition of 0.5% succinic acid and 100 ppm of dihydroeugenol (group C), diet A with addition of 0.25% succinic acid and 200 ppm of dihydroeugenol (group D) and the diet A with addition of 0.25% succinic acid and 100 ppm of dihydroeugenol (group E), respectively.

The basal diet A was formulated to meet the animals' requirements. The composition of the basal diet is presented in the table 9.

Performance was evaluated for the first 12 days of the experiment and for the whole observation period. The health status has been controlled daily.

Statistical treatment of the results involved the calculation of the mean and the standard deviation of the mean as well as a two-factor hierarchical analysis of variance. The mathematical model was:

Yijk=μ+Ai+Bij+Zijk

were μ is the overall mean, Ai is the diet effect, Bij is the combined effect the diet and animal or pen and Zijk is the residual term. The analysis of variance was followed by Student's “t” test when a significant Ai effect without Bij effect was observed. These calculations were performed using StatBox™ (GRIMMER Logiciels, Paris, France. 2001). Feed intake and feed conversion ratio (FCR) data were analysed using the pen as experimental unit, whereas daily weight gain (DWG) was analysed using the individuals as experimental unit.

The results show that all the supplemented groups have better DWG (daily weight gain) in both periods of observation than that observed for the control group (table 10). During the first 12 days the differences between the control group and the groups D and E were statistically significant and those of the groups B and C very close to the significance. The feed intake was generally increased by the dietary supplementation (table 3). The FCR was strongly numerically improved during the first 12 days and in a more moderate form for the all observation period (table 11).

The present experiment demonstrated that succinic acid in combination with dihydroeugenol improved the zootechnical performance of the weaner piglet.

TABLE 9
Composition and characteristics (%) of the experimental diets

| Ingredients (%) | A | B | C | D | E |
|---|---|---|---|---|---|
| Soya bean meal | 7.5 | | | | |
| Wheat | 18.8 | | | | |
| Barley | 29 | | | | |
| Potato concentrate | 8 | | | | |
| Maize | 10 | | | | |
| Oat meal | 10 | | | | |
| Beet pulp | 5.4 | | | | |
| Beet sugar | 3.5 | | | | |
| Soy oil | 2.7 | | | | |
| Wheat starch | 1.6 | | | | |
| Minerals, trace elements | 3.5 | | | | |
| and vitamins premix(1) | | | | | |
| Succinic acid (%) | 0 | 0.5 | 0.5 | 0.25 | 0.25 |
| Dihydroeugenol (ppm) | 0 | 200 | 100 | 200 | 100 |

(1)mixture without organic acids

TABLE 10
Effects of succinic acid in combinations with dihydroeugenol
on the piglet weight gain and mortality.

| | | | | |
|---|---|---|---|---|
| A (n = 24) | B (n = 24) | C (n = 24) | D (n = 24) | E (n = 24) |

Daily weight gain (g) - D 0-12

| | | | | |
|---|---|---|---|---|
| 98 ± 42a | 128 ± 46ab* | 128 ± 43 ab** | 151 ± 39b | 144 ± 37b |
| (100) | (131) | (131) | (155) | (147) |

Daily weight gain (g) - D 0-32

| | | | | |
|---|---|---|---|---|
| 240 ± 47 | 252 ± 54 | 235 ± 63 | 254 ± 62 | 268 ± 57 |
| (100) | (105) | (98) | (106) | (112) |

Total weight gain (kg) - D 0-32

| | | | | |
|---|---|---|---|---|
| 7.68 ± 1.49 | 8.08 ± 1.74 | 7.51 ± 2.03 | 8.12 ± 1.97 | 8.57 ± 1.83 |
| (100) | (105) | (98) | (106) | (112) |

A - basal diet,
B - A + 0.5% of succinic acid + 200 ppm of dihydroeugenol,
C - A + 0.5% of succinic acid + 100 ppm of dihydroeugenol,
D - A + 0.25% of succinic acid + 200 ppm of dihydroeugenol and
E - A + 0.25% of succinic acid + 100 ppm of dihydroeugenol
Animals: 28 days old weaners of an initial body weight of 8 ± 0.84 kg; diet based on soy bean meal, wheat and barley;
a, b - in the same row values with different superscript letters were statistically different:
a-bP < 0.005;
*P < 0.07;
**P < 0.06.

TABLE 11
Effects of succinic acid in combinations with dihydroeugenol
on the piglet feed intake and feed conversion ratio.

| | | | | |
|---|---|---|---|---|
| A (n = 4) | B (n = 4) | C (n = 4) | D (n = 4) | E (n = 4) |

Feed intake (g/day) - D 0-12

| | | | | |
|---|---|---|---|---|
| 218 ± 33 | 223 ± 30 | 226 ± 16 | 245 ± 14 | 251 ± 3 |
| (100) | (103) | (104) | (113) | (115) |

Feed intake (g/day) - D 0-32

| | | | | |
|---|---|---|---|---|
| 418 ± 43 | 436 ± 51 | 419 ± 45 | 453 ± 45 | 470 ± 12 |
| (100) | (104) | (100) | (108) | (112) |

Feed conversion ratio (kg/kg) - D 0-12

| | | | | |
|---|---|---|---|---|
| 2.972 ± 1.331 | 1.922 ± 0.234 | 1.838 ± 0.269 | 1.655 ± 0.128 | 1.75 ± 0.144 |
| (100) | (65) | (62) | (56) | (59) |

Feed conversion ratio (kg/kg) - D 0-32

| | | | | |
|---|---|---|---|---|
| 1.83 ± 0.08 | 1.769 ± 0.04 | 1.799 ± 0.06 | 1.786 ± 0.05 | 1.748 ± 0.09 |
| (100) | (97) | (98) | (98) | (96) |

A - basal diet,
B - A + 0.5% of succinic acid + 200 ppm of dihydroeugenol,
C - A + 0.5% of succinic acid + 100 ppm of dihydroeugenol,
D - A + 0.25% of succinic acid + 200 ppm of dihydroeugenol and
E - A + 0.25% of succinic acid + 100 ppm of dihydroeugenol
Animals: 28 days old weaners of an initial body weight of 8 ± 0.84 kg; diet based on soy bean meal, wheat and barley.

1. Use of succinic acid or a derivative thereof in the preparation of a composition for use in animal feed.

2. Use according to claim 2 in the manufacture of a nutraceutical composition for improving the feed conversion ratio (FCR), and/or modulating the gut microflora.

3. Use according to claim 1, wherein derivatives of succinic acid include salts of succinic acid such as the alkali metal-alkaline earth metal- and ammonium succinates.

4. Feed or animal feed additive comprising as active ingredient succinic acid, a derivative or metabolite thereof.

5. Feed or animal feed additive according to claim 4 comprising as active ingredient a salt of succinic acid.

6. An animal feed additive according to claim 4 comprising
(a) at least one fat-soluble vitamin,
(b) at least one water-soluble vitamin,
(c) at least one trace mineral, and/or
(d) at least one macro mineral.

7. An animal feed or feed additive according to claim 4, comprising in addition to succinic acid dihydroeugenol.

8. Animal feed or feed additive according to claim 4, which improves animal feed utilization by improving the feed conversion ratio (FCR), and/or modulating the gut microflora.

9. An animal feed composition according to claim 5 having a crude protein content of 50 to 800 g/kg feed.

10. Composition according to claim 6, which is an anti-bacterial, anti-fungal and/or malodour counteracting composition.

11. A method of feeding an animal with a feedstuff, wherein succinic acid is added to the feed.

12. A method according to claim 11, wherein of feeding an animal with a feedstuff, wherein in addition to succinic acid dihydroeugenol is added to the feed.

13. A method for improving animal feed conversion ratio (FCR) and/or modulating animal gut microflora, wherein succinic acid or a derivative thereof is added to the feed.
